(19) United States
(12) Patent Application Publication
(10) Pub. No.: US 2016/0005112 A1
(43) Pub. Date: Jan. 7, 2016

(54) Business Methods for Providing a Selective Research Funding Portal

(71) Applicant: Moshe ROGOSNITZKY, Telz Stone (IL)

(72) Inventor: Moshe Rogosnitzky, Telz Stone (IL)

(21) Appl. No.: 14/777,499

(22) PCT Filed: Mar. 17, 2014
(86) PCT No.: PCT/IB2014/059907

§ 371 Date: Sep. 15, 2015

Related U.S. Application Data
(60) Provisional application No. 61/787,548, filed on Mar. 15, 2013.

(51) Int. Cl. G06Q 40/00; G06Q 10/06

(52) U.S. Cl. CPC G06Q 40/00; G06Q 10/063114

(57) ABSTRACT

A selective research funding portal, including a centralized database encoded on a computer readable-medium, a collecting mechanism for collecting information regarding research in need of funding, a peer-review mechanism for vetting collected information, and an access mechanism for providing access to unvetted and vetted information in electronic communication with the centralized database, and a method of using the selective research funding portal by submitting proposals for research funding to the portal, peer-reviewing the proposals, providing access to non-peer-reviewed and peer-reviewed proposals to interested individuals, and the interested individuals selectively funding the peer-reviewed proposals.

### BACKGROUND OF THE INVENTION

1. Technical Field

The present invention relates to research funding. More specifically, the present invention relates to business methods and portal interfaces to aid in funding research.

2. Background Art

Victims of disease and their families donate billions of dollars each year to medical research in the hope of finding a cure in time to save their lives or the lives of their loved ones. Many of them scour the Internet, seeking worthwhile projects to fund. Yet these lay people don't have the skills or knowledge to discern which research projects from the multitude available may offer the fastest path to a cure.

From the research perspective, no systematic way exists for medical researchers to find individual donors who may be the most motivated to support their research. It is not unusual for researchers and scientists to spend up to a third of a year annually in writing grant applications to seek funding from government agencies and foundations instead of conducting life-saving research. Competing needs for government funding results in only 9% of research grant applications being granted.

Furthermore, there may be thousands of researchers independently studying a particular ailment such as prostate cancer or multiple sclerosis. Lay donors lack the tools to evaluate which research projects offer the greatest possible return on investment in terms of quickly developing effective clinical treatments. There is tremendous potential for saving lives and ending suffering by making the medical-research funding process more effective and efficient.

There are several portals (i.e. web-based databases) for donation that exist, such as Network for Good, Just Giving, and Just 2 Give. While some portals require beneficiaries to be a 501(c)(3) (government recognized) charity, others allow any selected beneficiary to receive donations, such as for raising funds for an organization, family or person in need. In other words, there is no independent vetting of charitable causes to determine which causes are worthy or can have the largest impact on people or provide rapid results capable of benefiting the donor who may be suffering from a serious medical disorder and wishes to support related research. Furthermore, once the funds have been released to the beneficiary, there is no oversight of spending or holding the solicitor accountable for the funds in any way.

It would be desirable to have methods for providing a selective research-funding portal. Such methods would, inter alia, overcome the various limitations mentioned above and provide a marketplace for “buyers” (including subscribers, researchers, and sponsors) and “sellers” (including submitters, practitioners, and researchers) of medical research to convene in a unified and supervised framework to bridge gaps, share information, connect people with common interests, and execute selective business transactions. It would further be desirable to provide credibility to projects with scientific peer review, provide accountability of projects, and focus on projects that provide rapid results.

### SUMMARY OF THE INVENTION

The present invention provides for a selective research funding portal, including a centralized database encoded on a computer readable-medium, and a collecting mechanism for collecting information regarding research in need of funding, a peer-review mechanism for vetting collected information, and an access mechanism for providing access to both unvetted and vetted information in electronic communication with the centralized database.

The present invention also provides for a method of using the selective research funding portal by submitting proposals for research funding to the portal, peer-reviewing the proposals, providing access to peer-reviewed proposals and non-peer-reviewed information to interested individuals, and the interested individuals selectively funding the peer-reviewed proposals.

### DESCRIPTION OF THE DRAWING

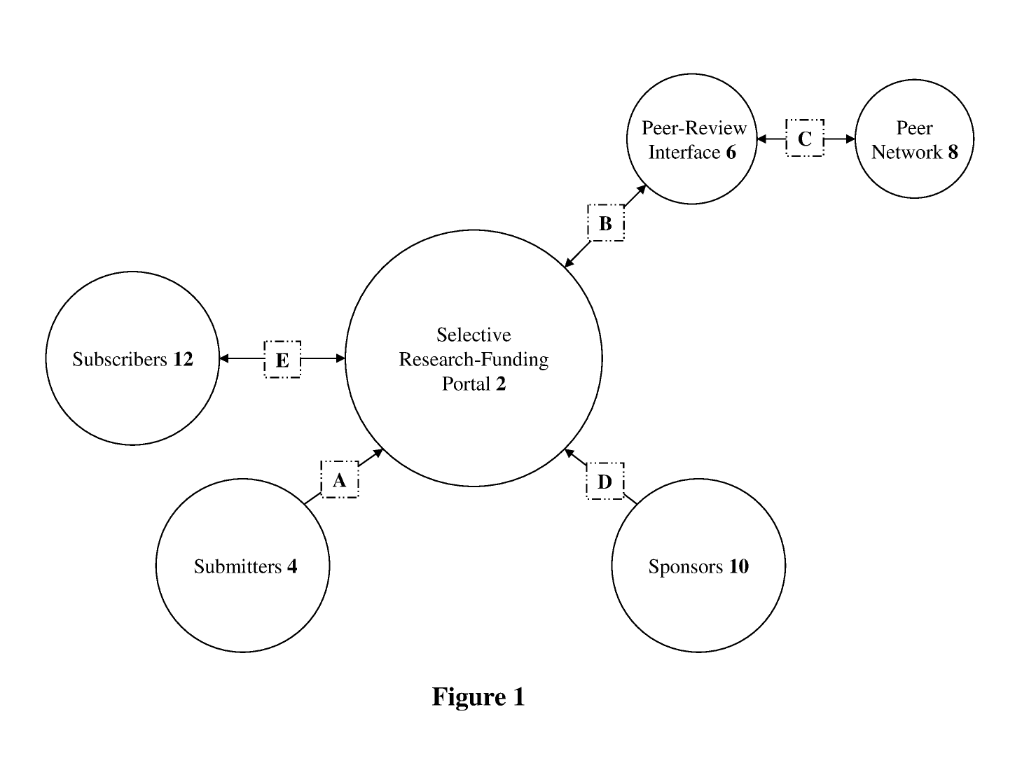

Other advantages of the present invention are readily appreciated as the same becomes better understood by reference to the following detailed description when considered in connection with the accompanying drawings wherein FIG. 1 is a schematic block diagram of information flow in the selective research funding portal.

### DETAILED DESCRIPTION OF THE INVENTION

The present invention generally provides for a selective research funding portal that connects submitters, subscribers, sponsors, and peer-reviewers and collects information regarding research in need of funding with a collection mechanism, vets the collected information with a peer-review mechanism, and provides access to the vetted information in a centralized database with an access mechanism, all of which are in electronic communication with the portal and databases therein.

The term “selective research funding” is used herein to refer to the funding of research in which the funder can designate funds selectively to specific research projects. The “funders” can include the “sponsors” and any private donors, foundations, NGO's, pharmaceutical companies, governments, and any interested individual. Preferably, the research projects that are funded include, but are not limited to, rapid result projects, i.e. clinical trials studying off-label use of existing drugs/devices (or repurposing of an existing drug/device), clinical trials that enable personalization of existing treatments, clinical trials regarding drugs/devices that do not require regulatory approval (i.e. nutritional supplements, botanicals, nutraceuticals and similar therapies), and clinical studies of interventions not subject to regulatory approval (such as acupuncture, physical therapies, lifestyle interventions, etc). Rapid results projects (i.e. 1-2 years from trial initiation to completion and publication) are only achievable by focusing clinical (i.e. human) research on already approved drugs such as off-label uses of drugs (or drug repurposing), non-pharmaceutical interventions such as nutritional supplements, botanicals and nutraceuticals, or methods of personalizing existing medical therapy. However, any type of research project can be submitted by a submitter for funding.

The term “submitters” is used herein to refer to parties who seek to provide information regarding medical research and/or conduct new medical research through the submission of research proposals. The submitters can provide both technical professional information regarding their project for peer review and for other users who understand such technical information, as well as simplified information for non-technical users of the portal. This allows interested donors to understand the research they are funding even if they are not technically versed in that particular field of research.

The term “subscribers” is used herein to refer to parties who seek access to information regarding peer-approved research proposals and funded medical research. In that sense, the term “practitioners” in general is understood herein to be included within the definition of subscribers. Subscribers can include researchers, patients seeking trials, and any other organizations or individuals who have an interest in the information in the portal.

The term “sponsors” is used herein to refer to parties who support activities associated with medical research (e.g., publication support, research funding, patent protection, investment solicitation, marketing, information brokerage and commercialization endeavors). Such entities can include patients, charitable foundations, individual philanthropists, private backers, corporate investors, industry partners, pharmaceutical companies, non-profit endowments, governmental agencies, advertisers, venture capitalists, various fund managers, patent agents/attorneys and law firms.

As shown in FIG. 1, the selective research funding portal 2 is shown which provides a venue to submitters 4 for submitting research proposals, ideas, and study findings that is singularly focused on medical research. Remuneration for the peer review and presentation of such submitter content is provided via selective research-funding portal 2 through Transaction Process A. Such “transaction processes” are functional steps which can be performed with human intervention, but are always operationally implemented through a computerized network system. Any remuneration can be provided electronically.

Submitters 4 can include various forms of information in their proposals such as, but not limited to, a listing of professional credentials, a universally recognized researcher ID (such as SCOPUS Author ID, or ResearchGate user ID), a research description of a proposed project, expected results of the proposed project, motivation and evidentiary-supported reasoning justifying the project, and anticipated timelines to implement the project upon being funded. Such timelines are assessed by peer network 8 described below according to criteria such as, but not limited to, anticipated patient benefit within a projected timeframe, funds required for each step of the project, and feasibility of the experiments.

Proposals of submitters 4 are assessed for scientific integrity through a peer-review mechanism, i.e. a peer-review interface 6 which enables a peer network 8 (i.e. peer reviewers) to administer the peer-review process effectively and efficiently. Transaction Process B provides for such administration as peer categorization, peer selection, proposal dissemination, review anonymity, review feedback input and communication, and version tracking. Because the selective research funding portal 2 acts as a centralized access hub to innovations in research, Transaction Process C attracts the most suitable candidates to serve in peer network 8. During the peer-review, an initial review can be performed by an in-house physician or researcher to ensure a proposal meets certain criteria. The initial review can also include verification of submitter credentials and ensuring legal conditions have been accepted (governing how and when funds will be disbursed). Next, the proposal can be forwarded to peer reviewers in the peer network 8, in the specific field of the proposal, who can critique the logic of the proposed trial and/or design. The peer network 8 can rank proposals according to which research project is most likely to provide results and this ranking can be listed on the portal. Alternatively, if a proposal is deemed not as likely to succeed, the peer network 8 can deny its listing on the portal. While a proposal can have a separate peer-review outside of the portal before submission, preferably proposals have not had any peer-review before submission and the peer network 8 is used. A proposal will not be accessible to sponsors and subscribers until peer-review has taken place with the peer network 8. Limited information about a proposal can be available to the sponsors 10 prior to peer-review and not contingent on the peer-review results. This allows sponsors 10 to solicit the submitters 4 for various services (such as IP and licensing) so that these services can be taken advantage of as early as possible before publication within the portal. Therefore, even submitters 4 who submit proposals that are rejected by the peer network 8 can still benefit from using the portal 2.

The peer-review mechanism can also be automated at any point, so that a proposal can be automatically sent to a particular peer network 8 in that field of research. For example, based on certain key words within the proposal or within a certain field, the proposal can be sent to a particular peer network 8. This allows for the unexpected results of much quicker access to proposals by subscribers 12 and sponsors 10 through the portal 2 and quicker publication of the proposals such that the public has access and can obtain use from the proposals. This provides researchers seeking funding access to funders faster than previously.

Once a proposal has successfully been peer-reviewed, it can be stored and accessed on the selective research funding portal 2. Essentially, the selective research funding portal 2 includes a database that stores each of the proposals that have been peer-reviewed. Submitters 4 whose research proposals have been approved by the peer network 8 can be held accountable for the funding received through milestone submission and assessment on the portal 2. Additional funding can be contingent on meeting approved milestone timelines, ensuring sponsors' funds are used appropriately, and research milestones are reached in a timely manner. Milestones can also include objective criteria, such as, but not limited to, peer-review score, publication of proposal, amount of funding achieved, presence of prior funding, and any other relevant information. This step can also be automated such that once the peer network 8 indicates that the proposal is ready to be accessed on the portal 2, it is automatically published on the portal 2.

Subscribers 12 engage the selective research funding portal 2 in order to obtain access to medical research information (i.e., peer-reviewed proposals, funded research projects, and project progress results such as milestones and assessments) supplied by peer-approved submissions of submitters 4. Subscribers 12 also engage the selective research funding portal 2 in order to access trial listings for purposes of patient recruitment. As some information can be pre-publication or confidential, access to this information can require subscribers 12 and sponsors 10 to sign non-disclosure agreements (NDAs), which can be automated within the portal 2. For example, a title of a proposal can be viewed, but in order to view further details, an electronic NDA must be signed and completed before access is granted. Remuneration for such access is provided via selective research funding portal 2 through Transaction Processes D and E. In other words, subscribers 12 and sponsors 10 can pay a fee (such as, but not limited to, a one time fee, a weekly fee, a monthly fee, or a yearly fee) in order to access the information on the portal. Any of the above steps can be automated.

Sponsors 10 engage the selective funding research portal 2 for a host of reasons depending on the type of stakeholder they are. Preferably, sponsors 10 choose to selectively fund certain research that they are interested in. Payment of funds can occur through the selective research funding portal 2 via a secure payment or funds transfer mechanism (such as, but not limited to, PAYPAL™). Any funds that are assigned to a particular project are disbursed according to agreed timelines to the researchers (i.e. the submitters 4). Transaction Process D serves in part as a revenue stream (i.e. a revenue generating mechanism) for maintaining the processes described above for selective research funding portal 2. Any of the above steps can be automated.

A portion of any resulting intellectual property rights resulting from research conducted by funded submitters 4 (Transaction Process A), as well as a percentage of all donated funds by sponsors 10 (Transaction Process D), can serve in part as a revenue stream for maintaining the processes described above for selective research funding portal 2. In other words, in order to use the portal 2, submitters 4 can be required to assign a percentage of their intellectual property rights to the selective research funding portal 2. A form can be signed electronically by the submitters 4 agreeing to this upon submission of a proposal. Similarly, sponsors can be required to sign a form electronically acknowledging that a percentage of their donation goes to the maintenance of the selective research funding portal 2. As the selective research funding portal 2 can be a not-for-profit organization, and donations flow through the portal 2 to fund the research proposals, a percentage of all donations can be withheld. Any of the above steps can be automated.

The selective research funding portal 2 is preferably encoded and stored with computer readable memory on a central server and can be accessed electronically over the Internet. In essence, the selective research funding portal 2 is a web-based interface and database. Access can be through an access mechanism such as a website or an application (i.e. app), and the selective research funding portal 2 can be viewed or displayed on a screen of a computer, laptop, tablet, smart phone, smart watch, or any other device capable of accessing the Internet. Any Transaction Process or access by an individual described above can be recorded in a database in order to keep track of use and provide statistics and reports. Any information or publication in the portal can be printed at any time, and reprints can be made for industry. These prints provide a technical effect of a tangible object available to users of the portal 2.

The selective research funding portal 2 can provide a search mechanism to search for any peer-reviewed proposal, funded research projects, and project progress results in the database. The search mechanism can use search terms such as, but not limited to, diseases, conditions, uses, submitter names, peer network names, date, and subject.

The selective research funding portal 2 can also provide alerts to any of the users regarding activity and proposals within the selective research funding portal 2. For example, alerts can be sent to peer network 8 when a submitter 4 has sent a relevant proposal to the portal 2. Subscribers 12 and sponsors 10 can also receive alerts if a proposal of interest (such as regarding a certain medicine, disease or condition) has been provided to the portal 2, or if any updates or progress results have been provided to a project. Sponsors 10 can also receive alerts upon submission of a proposal before peer-review has occurred. Alerts can be in the form of text messages, screen alerts on a smart phone or tablet, emails, sounds, RSS feed, or any other suitable type of alert. These alerts are technical effects that can prompt a user of the portal 2 to take an action.

The selective research funding portal 2 can further include social media mechanisms that can promote research projects, such as, but not limited to, FACEBOOK™ and TWITTER™ and LINKEDIN™. Submitters 4, subscribers 12, and sponsors 10 can each use the social media mechanisms to promote projects they are interested in or have donated to, and to encourage others to donate. The present invention enables grassroots fundraising in a scientifically-supervised framework by harnessing social-media technology in the portal 2 to help sponsors 10 promote their choice of research projects within their own social networks. Such viral-marketing techniques have already been proven effective on sites like Network for Good and Just Giving, with grassroots activists collectively raising tens of millions annually for charitable organizations they promote.

The present invention provides for a method of using the selective research funding portal 2 by submitting proposals for research funding to the portal, peer-reviewing the proposals, providing access to peer-reviewed proposals and non-peer-reviewed information to interested individuals, and the interested individuals selectively funding the peer-reviewed proposals.

More specifically, the submitters 4 submit proposals for clinical research to the portal 2, and the peer network 8 reviews the proposals in the peer-review interface 6. When the peer network 8 finds that the proposal is scientifically sound, the proposal can then be accessed by the subscribers 12 and sponsors 10 on the selective research funding portal 2. Sponsors 10 can also access limited information about the proposals before peer-review has occurred in order to provide services to submitters 4 as described above. Once funded, submitters 4 update their proposals and projects with milestones and assessments, and obtaining further funding can be contingent on meeting particular milestones and assessments. In other words, submitters 4 can submit this information to the collecting mechanism through the portal 2. Remuneration can be provided to submitters and the peer network as an incentive to submit proposals and review proposals. Subscribers 12 and sponsors 10 can pay to gain access to the selective research funding portal; however, subscribers 12 can alternatively access the portal for free. As described above, statistics and reports can be generated, and alerts can be generated.

The selective research funding portal provides several advantages. It provides a venue for facilitating selectively funded rapid-results-oriented medical research by enabling sponsors to contribute to specific, worthy research projects according to their interests. The selective research funding portal 2 also enables a centralized access hub for funded medical research. The selective research funding portal 2 can operate as a comprehensive, “research clearinghouse” platform, allowing submitters 4 of peer-approved submissions and sponsors 10 to find each other. Such a platform provides an array of viable, vetted medical research projects that are worthy of support, facilitating accelerated funding cycles in a crowd-sourced-like fashion with the rigor of scientific oversight of a peer network as an evaluation board and fiscal oversight of use of funds (though ensuring milestones are met). Such accelerated funding cycles resulting in accelerated research-discovery cycles.

The present invention enables sponsors to fund projects with confidence, knowing that each project has been peer-reviewed by world-class scientific experts serving on the evaluation board.

The present invention facilitates the evaluation of medical-research funding requests in order for foundations and other sponsors to concentrate donations on projects that are most likely to produce clinical results in the shortest amount of time through the portal's independent evaluation board. Due to the peer review process, only scientifically worthy projects are listed in the portal 2. Such benefits allow scientists, physicians, and other researchers to spend more time curing diseases, and less time chasing research dollars.

The present invention facilitates the funding of research for rare disorders, off-label uses of approved medications, and research of therapeutic agents not subject to health-authority use controls—three areas of research that are severely under-funded through regular channels. The peer review process can specifically select those projects involved in rare disorders and off-label uses as projects that will most likely produce results so that these projects can be funded. Often, just a few thousand dollars in research funding can make an important difference in saving lives.

The present invention further allows sponsors 10 access to non-peer-reviewed information, and such access results in the ability to file for IP protection, such possibility being lost once a proposal is published. Currently, there is no option for this service with current portals or funding agencies (such as National Institutes of Health and others), hence many researchers who are unaware of the ability to file for IP protection lose their rights through public disclosure. This is an unexpected step because funding agencies are bound by extreme levels of trust not to publicize any information prior to publication. The very notion of selectively sharing information pre-funding (grant)-approval is unexpected, and the present invention provides advantages for the submitters 10 to gain access to services made available by the sponsors 12.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A selective research funding portal, comprising a centralized database encoded on a computer readable-medium, collecting means for collecting information regarding research in need of funding, peer-review means for vetting collected information, and access means for providing access to unvetted information and said vetted information in electronic communication with said centralized database.

2. The selective research funding portal of claim 1, wherein said selective research funding portal connects submitters, subscribers, sponsors, and peer-reviewers.

3. The selective research funding portal of claim 2, wherein said collecting means is further defined as a submission mechanism that collects proposals from said submitters.

4. The selective research funding portal of claim 3, wherein said peer-review means includes a peer review interface enabling said peer network to peer-review said proposals.

5. The selective research funding portal of claim 4, wherein said peer review interface provides an administration function chosen from the group consisting of peer categorization, peer selection, proposal dissemination, review anonymity, review feedback input and communication, version tracking, and combinations thereof.

6. The selective research funding portal of claim 2, wherein said access means provides access of peer-reviewed proposals to said subscribers and sponsors and provides access of non-peer-reviewed information to said sponsors.

7. The selective research funding portal of claim 2, wherein said collecting means further collects information chosen from the group consisting of milestones and assessments of proposals.

8. The selective research funding portal of claim 2, further including a revenue generating mechanism from said sponsors.

9. The selective research funding portal of claim 2, wherein said selective research funding portal is accessible over the Internet through a mechanism chosen from the group consisting of a website and an application.

10. The selective research funding portal of claim 2, wherein said selective research funding portal is viewed on a device chosen from the group consisting of a computer, laptop, tablet, smart phone, and smart watch.

11. The selective research funding portal of claim 2, further including a tracking mechanism for tracking use of said selective research funding portal, a statistics mechanism, and a reporting mechanism in electronic communication with said selective research funding portal.

12. The selective research funding portal of claim 2, further including search means for searching said peer-reviewed proposals, funded research projects, and project progress results.

13. The selective research funding portal of claim 2, further including alert means for alerting a user regarding activity within said selective research funding portal.

14. The selective research funding portal of claim 2, further including remuneration means for providing remuneration to said submitters and peer-reviewers and generating remuneration from said subscribers.

15. A method of using a selective research funding portal, including the steps of:
submitting proposals for research funding to the selective research funding portal;
peer-reviewing the proposals;
providing access to peer-reviewed proposals to interested individuals; and
the interested individuals selectively funding the peer-reviewed proposals.

16. The method of claim 15, wherein the interested individuals are chosen from the group consisting of subscribers, sponsors, and combinations thereof.

17. The method of claim 16, wherein said peer-reviewing step further includes a step chosen from the group consisting of peer categorizing, peer selecting, proposal disseminating, providing review anonymity, providing review feedback input and communication, providing version tracking, and combinations thereof.

18. The method of claim 16, further including the step of accessing the selective research funding portal through the Internet by a mechanism chosen from the group consisting of a website and an application.

19. The method of claim 16, further including the step of displaying the selective research funding portal on a device chosen from the group consisting of a computer, laptop, tablet, smart phone, and smart watch.

20. The method of claim 16, further including the step of generating revenue from donated funds from the sponsors and from intellectual property rights from funded submitters.

21. The method of claim 16, further including the step of providing remuneration to submitters submitting proposals and peer-reviewers peer-reviewing the proposals and wherein said providing access step further includes the step of collecting payment from subscribers and sponsors to gain access to the selective research funding portal.

22. The method of claim 16, further including the step of requiring that the submitters meet milestones and assessments to obtain further funding.

23. The method of claim 16, further including the step of providing statistics and reports of use of the selective research funding portal.

24. The method of claim 16, wherein said providing access step further includes the step of searching for peer-reviewed proposals, funded research projects, and project progress results.

25. The method of claim 16, further including the step of alerting a user of the selective research funding portal regarding a proposal.
